(19) United States
(12) Patent Application Publication
(10) Pub. No.: US 2020/0355198 A1
(43) Pub. Date: Nov. 12, 2020

(54) IMPELLER FOR CENTRIFUGAL COMPRESSOR, CENTRIFUGAL COMPRESSOR, AND TURBOCHARGER

(71) Applicant: MITSUBISHI HEAVY INDUSTRIES, LTD., Tokyo (JP)

(72) Inventors: Hironori HONDA, Tokyo (JP); Kenichiro IWAKIRI, Tokyo (JP); Isao TOMITA, Tokyo (JP); Yutaka FUJITA, Tokyo (JP)

(21) Appl. No.: 16/784,339

(22) Filed: Feb. 7, 2020

(30) Foreign Application Priority Data
May 10, 2019 (JP) 2019-089455

(51) Int. Cl. F04D 29/28

(52) U.S. Cl. CPC F04D 29/284; F05D 2220/40; F05D 2240/304

(57) ABSTRACT

An impeller for a centrifugal compressor includes a plurality of blades arranged around a hub, and on a trailing edge of the blade, a blade angle at a first position on a shroud side from a center position in a span direction of the blade is larger than a blade angle at a second position on a hub side from the center position.

### TECHNICAL FIELD

This disclosure relates to an impeller for a centrifugal compressor, a centrifugal compressor, and a turbocharger.

### BACKGROUND

In some cases, an impeller of a centrifugal compressor is designed to be capable of improving performance of the centrifugal compressor.

For example, Patent Document 1 discloses that, regarding an impeller of a compressor used for a turbocharger, a trailing edge in the vicinity of a hub of a blade is shaped to have a convex curve line shape while a portion including the trailing edge of the blade is protruded radially-outside a back plate, so that performance of the compressor is improved while suppressing stress increase.

### CITATION LIST

### Patent Literature

Patent Document 1: JP5538240B

### SUMMARY

By the way, since a shroud-side end (leading end) of a blade is located radially-outside a hub-side end at an inlet of an impeller of a centrifugal compressor, a blade speed of the impeller at the shroud side is relatively larger than that at the hub side, and therefore, a relative velocity of fluid with respect to the impeller is relatively large as well. When, at an inlet of the impeller, a difference of the relative velocities of the fluid exists between those at the shroud side and the hub side, there may be a case that fluid flow becomes non-uniform at the outlet of the impeller as being caused thereby. In such a case, performance of the compressor may be deteriorated.

In this regard, it is an object of at least one embodiment of the present invention to provide an impeller for a centrifugal compressor capable of improving performance of the centrifugal compressor, a centrifugal compressor, and a turbocharger.

(1) An impeller for a centrifugal compressor according to at least one embodiment of the present invention includes a plurality of blades arranged around a hub, and on a trailing edge of the blade, a blade angle at a first position on a shroud side from a center position in a span direction of the blade is larger than a blade angle at a second position on a hub side from the center position.

At a leading edge of the blade of the centrifugal compressor, since the shroud side (leading end side) is located radially-outside the hub side, a blade speed of the blade and a relative velocity of fluid with respect to the blade at the shroud side are larger than those at the hub side. On the other hand, since the trailing edge of the blade stays at approximately the same position in the radial direction from a hub-side end to a shroud-side end (leading end), there is not a large difference of the blade speeds and the relative velocities. Accordingly, a reduction ratio of the fluid at the shroud side of the blade becomes larger than that at the hub side and blade load at the shroud side tends to be excessively large.

In this regard, according to the configuration described above as (1), at the trailing edge of the blade, since the blade angle (backward angle) at the shroud side is larger than that at the hub side, the relative velocity of the fluid at the shroud side at a position on the trailing edge of the blade becomes larger than that at the hub side. Accordingly, the reduction ratio at the shroud side can be caused to be close to the reduction ratio at the hub side, so that blade load at the shroud side can be suppressed from becoming excessively large. According to the above, occurrence of flow separation and secondary flow due to excessively large blade load can be suppressed, and therefore, performance of the centrifugal compressor can be improved.

(2) In some embodiments, in the configuration described above as (1), β_{2,hub} and β_{2,shroud} satisfy β_{2,hub}<β_{2,shroud}, where β_{2,hub} represents a blade angle at a position on the trailing edge and on a hub-side end of the blade and β_{2,shroud} represents a blade angle at a position on the trailing edge and on a shroud-side end of the blade.

The tendency that the reduction ratio of the fluid becomes large at the blade is most likely to be apparent at the shroud-side end which is located at the outermost position on the leading edge in the radial direction, and therefore, the tendency that the blade load becomes excessively large is most likely to be apparent at the shroud-side end. In this regard, according to the configuration described above as (2), since the backward angle β_{2,shroud} at the shroud-side end is set larger than the backward angle β_{2,hub} at the hub-side end, the reduction ratio at the shroud-side end can be set close to the reduction ratio at the hub-side end. Accordingly, blade load at the shroud side of the blade can be effectively suppressed from becoming excessively large, and therefore, occurrence of flow separation and secondary flow due to excessively large blade load can be effectively suppressed.

(3) In some embodiments, in the configuration described above as (2), β_{2,hub} and β_{2,shroud} satisfy β_{2,shroud}-β_{2,hub}≥5°.

According to the configuration described above as (3), since the backward angle β_{2,shroud} at the shroud-side end is set larger than the backward angle β_{2,hub} at the hub-side end by 5° or more, the reduction ratio at the shroud side can be easily set close to the reduction ratio at the hub side, so that the blade load at the shroud side can be suppressed from becoming excessively large more effectively. Accordingly, occurrence of flow separation and secondary flow due to excessively large blade load can be suppressed more effectively.

(4) In some embodiments, in the configuration described above as (2) or (3), β_{2,hub} and β_{90%,hub} satisfy |β_{90%,hub}-β_{2,hub}|≤10°, where β_{90%,hub} represents a blade angle at a 90%-dimensionless meridian plane lengthwise position on the hub-side end of the blade.

(5) In some embodiments, in the configuration described above as any one of (2) to (4), β_{2,shroud} and β_{90%,shroud} satisfy |β_{90%,shroud}-β_{2,shroud}|≤10°, where β_{90%,shroud} represents a blade angle at a 90%-dimensionless meridian plane lengthwise position on the shroud-side end of the blade.

When the blade angle varies drastically in the vicinity of the trailing edge of the blade (i.e., in a positional range from a position slightly closer to the leading edge than the trailing edge to the trailing edge), there arise possibilities that flow in the positional range does not follow the blade and that the effect to be obtained with the configuration described above as (1), that is, the effect to suppress occurrence of flow separation and secondary flow due to excessively large blade load cannot be obtained.

In this regard, according to the configuration described above as (4) or (5), since the difference between the blade angle β_{90%,shroud} at a 90%-dimensionless meridian plane lengthwise position of the blade and the backward angle β_{2,shroud} is set equal to or smaller than 10°, variation of the blade angle in the vicinity of the trailing edge of the blade becomes relatively gradual. Accordingly, the effect to be obtained with the configuration described above as (1), that is, the effect to suppress occurrence of flow separation and secondary flow due to excessively large blade load can be sufficiently obtained.

(6) In some embodiments, in the configuration described above as any one of (1) to (5), a blade angle at a position on the trailing edge of the blade monotonically decreases from a shroud-side end of the blade to a hub-side end of the blade.

Since the reduction ratio of the fluid at the blade approximately depends on a radial position at a position of the leading edge of the blade, there is a tendency that the reduction ratio is the largest at the shroud-side end being the outermost radial position and becomes gradually smaller toward the hub side. In this regard, according to the configuration described above as (6), since the backward angle monotonically decreases from the shroud-side end to the hub-side end, the reduction ratio at the shroud side can be effectively reduced, and therefore, blade load at the shroud side can be suppressed from becoming excessively large. Accordingly, occurrence of flow separation and secondary flow due to excessively large blade load can be suppressed more effectively.

(7) In some embodiments, in the configuration described above as any one of (1) to (6), R_{2,hub} and R_{2,shroud} satisfy R_{2,hub}<R_{2,shroud}, where R_{2,hub} represents a distance between a center axis of the impeller and the hub-side end on the trailing edge of the blade and R_{2,shroud} represents a distance between the center axis and the shroud-side end on the trailing edge of the blade.

Due to causing backward angles to have a distribution as the configuration described above as (1), the difference of absolute velocities of the fluid at the trailing edge of the blade occurs between those at the hub side and the shroud side, and thereby, mixing loss may be caused. In this regard, according to the configuration described above as (7), since the shroud side of the trailing edge of the blade is located radially-outside the hub side, the blade speed of the blade at the shroud side can be relatively large, and thereby, the difference of absolute velocities of the fluid between those at the shroud side and the hub side can be reduced. Accordingly, mixing loss to be caused by the difference of the absolute velocities of the fluid at the outlet of the impeller can be suppressed.

(8) In some embodiments, in the configuration described above as (7), an angle formed, on a meridian plane of the impeller, between an axial direction of the impeller and a straight line connecting the shroud-side end and the hub-side end on the trailing edge of the blade is 60° or smaller.

According to the configuration described above as (8), since the angle described above is set equal to or smaller than 60°, positional difference in the radial direction between the hub-side end and the shroud-side end at the trailing edge of the blade is not excessively large, and thereby, stress occurring at the blade can be suppressed from being increased.

(9) In some embodiments, in the configuration described above as (7) or (8), an outer diameter D of the impeller, on a meridian plane of the impeller, in a first region in an axial range including a position on the trailing edge and on the shroud-side end satisfies D_{2,shroud}−0.01×D_{2,hub}≤D≤D_{2,shroud}+0.01×D_{2,hub}, where D_{2,hub} represents an outer diameter of the impeller at the hub-side end and D_{2,shroud} represents an outer diameter of the impeller at the shroud-side end.

(10) In some embodiments, in the configuration described above as any one of (7) to (9), an angle φ formed, on a meridian plane of the impeller, between an axial direction of the impeller and a tangential direction of the trailing edge in a first region in an axial range including a position on the trailing edge and on the shroud-side end is 5° or smaller.

There may be a case that reverse flow is likely to occur at the shroud side depending on operational conditions of the centrifugal compressor (e.g., low flow velocity conditions). In this regard, according to the configuration described above as (9) or (10), since the first region including the shroud-side end at which the outer diameter of the impeller is relatively large and does not vary largely is arranged at the shroud side of the blade, the impeller blade speed can be set relatively large in the first region, and thereby, reverse flow which may occur at the shroud side can be effectively suppressed. Thus, according to the configuration described above as (9) or (10), mixing loss due to the difference of absolute velocities of the fluid at the outlet of the impeller can be suppressed while suppressing reverse flow which may occur at the shroud side, as described with reference to the configuration described above as (7).

(11) In some embodiments, in the configuration described above as (9) or (10), on the meridian plane of the impeller, b₂ and b_{const} satisfy b_{const}≤0.5×b₂, where b₂ represents a length in the axial direction between the shroud-side end at a position on the trailing edge of the blade and the hub-side end at a position on the trailing edge, and b_{const} represents a length of the first region in the axial direction.

According to the configuration described above as (11), since the length of the first region in the axial direction in which the outer diameter D of the impeller does not vary largely is set to equal to or lower than 50% of the length of the trailing edge of the blade in the axial direction, mixing loss due to the difference of the absolute velocities of the fluid at the outlet of the impeller can be effectively suppressed while appropriately maintaining strength of the blade.

(12) In some embodiments, in the configuration described above as any one of (9) to (11), on the meridian plane of the impeller, a ratio β_{2,R1-max}/β_{2,R1-min} which is a ratio of a maximum value β_{2,R1-max} to a minimum value β_{2,R1-min} of blade angles in the first region on the trailing edge of the blade is smaller than a ratio β_{2,R2-max}/β_{2,R2-min} which is a ratio of a maximum value β_{2,R2-max} to a minimum value β_{2,R2-min} of blade angles in a second region on the trailing edge of the blade, the second region being closer to the hub-side end than the first region on the trailing edge.

According to the configuration described above as (12), since the backward angle in the first region in which the outer diameter D of the impeller does not vary largely is set not to vary largely, both of suppression of mixing loss at the outlet of the impeller and suppression of excessively large blade load at the shroud side can be achieved while appropriately maintaining strength of the blade.

(13) A centrifugal compressor according to at least one embodiment of the present invention includes the impeller having the configuration described above as any one of (1) to (12), and a housing accommodating the impeller.

According to the configuration described above as (13), at the trailing edge of the blade, since the blade angle (backward angle) at the shroud side is larger than that at the hub side, the relative velocity of the fluid at the shroud side at a position on the trailing edge of the blade becomes larger than that at the hub side. Accordingly, the reduction ratio at the shroud side can be caused to be close to the reduction ratio at the hub side, so that blade load at the shroud side can be suppressed from becoming excessively large. According to the above, occurrence of flow separation and secondary flow due to excessively large blade load can be suppressed, and therefore, performance of the centrifugal compressor can be improved.

(14) In some embodiments, in the configuration described above as (13), the centrifugal compressor is a single-stage compressor including the impeller as a single impeller.

According to the configuration described above as (14), owing to that blades of the single impeller is shaped as specified in the configuration described as (1) in the single-stage compressor including the single impeller, occurrence of flow separation and secondary flow due to excessively large blade load can be suppressed, and therefore, performance of the compressor can be improved.

(15) A turbocharger according to at least one embodiment of the present invention includes the centrifugal compressor having the configuration described as (13) or (14), and a turbine configured to drive the centrifugal compressor.

According to the configuration described above as (15), at the trailing edge of the blade, since the blade angle (backward angle) at the shroud side is larger than that at the hub side, the relative velocity of the fluid at the shroud side at a position on the trailing edge of the blade becomes larger than that at the hub side. Accordingly, the reduction ratio at the shroud side can be caused to be close to the reduction ratio at the hub side, so that blade load at the shroud side can be suppressed from becoming excessively large. According to the above, occurrence of flow separation and secondary flow due to excessively large blade load can be suppressed, and therefore, performance of the centrifugal compressor can be improved.

At least one embodiment of the present invention provides an impeller for a centrifugal compressor capable of improving performance of the centrifugal compressor, a centrifugal compressor, and a turbocharger.

### BRIEF DESCRIPTION OF DRAWINGS

FIG. 1 is a schematic cross-sectional view of a turbocharger according to an embodiment.

FIG. 2 is a schematic view illustrating a cross-section on a meridian plane of an impeller according to an embodiment.

FIG. 3 schematically illustrates an iso-span cross-section of a blade of an impeller according to an embodiment, while part (a) of FIG. 3 is a schematic view of the iso-span cross-section at a hub-side end and part (b) of FIG. 3 is a schematic view of the iso-span cross-section at a shroud-side end.

FIG. 4 is a schematic cross-sectional view on a meridian plane of an impeller according to an embodiment.

FIG. 5 is a schematic view viewing, in an axial direction, an impeller according to an embodiment.

FIG. 6 is a graph illustrating an example of a distribution of radial flow velocities of fluid in a span direction at a position on a trailing edge of a blade.

FIG. 7 is a graph illustrating a distribution of backward angles of the blade in the span direction according to an embodiment.

FIG. 8 is a graph illustrating a distribution of blade angles of the blade at dimensionless meridian plane lengthwise positions according to an embodiment.

FIG. 9 is a schematic cross-sectional view on a meridian plane illustrating a vicinity of the trailing edge of the impeller according to an embodiment.

FIG. 10 is a schematic cross-sectional view on a meridian plane illustrating a vicinity of the trailing edge of the impeller according to an embodiment.

FIG. 11 is a schematic cross-sectional view on a meridian plane illustrating a vicinity of the trailing edge of the impeller according to an embodiment.

FIG. 12 schematically illustrates an iso-span cross-section of the blade of the impeller according to an embodiment, while part (a) of FIG. 12 is a schematic view of the iso-span cross-section at the hub-side end and part (b) of FIG. 12 is a schematic view of the iso-span cross-section at the shroud-side end.

FIG. 13 is a graph illustrating a distribution of backward angles of the blade in the span direction according to an embodiment.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

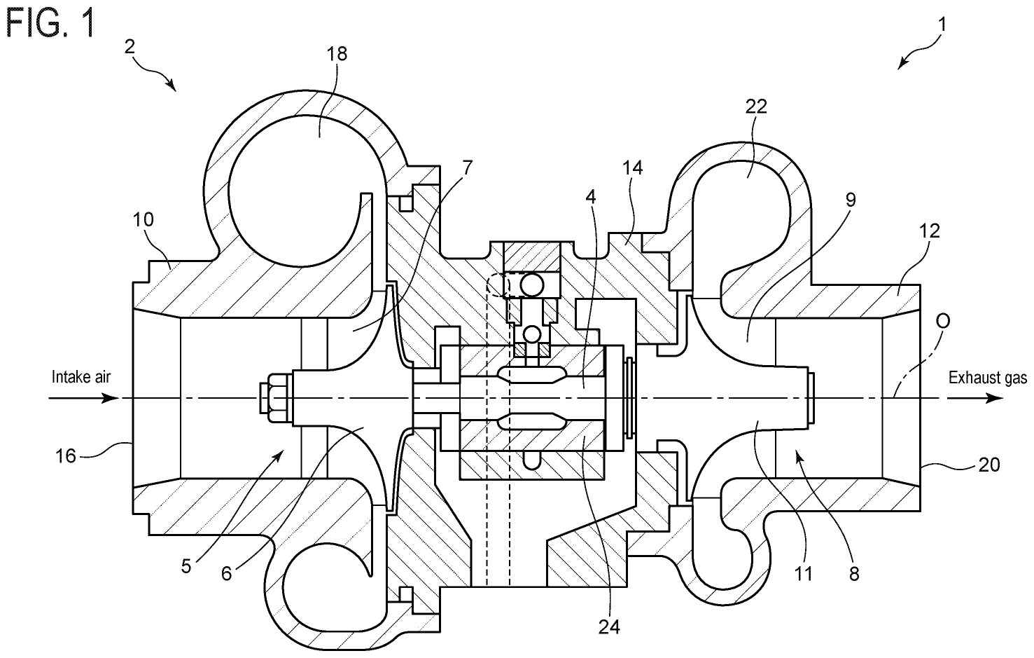

First, description will be provided on a turbocharger provided with a centrifugal compressor including an impeller according to an embodiment. FIG. 1 is a schematic cross-sectional view of a turbocharger according to an embodiment. As illustrated in FIG. 1, a turbocharger 1 is provided with a centrifugal compressor 2 including a compressor impeller 5. The turbocharger 1 includes a rotating shaft (rotary shaft) 4, the compressor impeller 5 (impeller 5) arranged at one end of the rotating shaft 4, a turbine wheel (turbine impeller) 8 arranged at the other end of the rotating shaft 4, and a bearing 24 rotatably supporting the rotating shaft 4. The bearing 24 is located between the compressor impeller 5 and the turbine wheel 8 in the axial direction of the rotating shaft 4.

The compressor impeller 5 includes a hub 6, and a plurality of blades 7 arranged around the hub 6. The turbine wheel 8 includes a hub 11, and a plurality of blades 9 arranged around the hub 11. The rotating shaft 4, the compressor impeller 5, and the turbine wheel 8 have a common center axis O.

Further, the turbocharger 1 includes a compressor cover (compressor housing) 10 accommodating the compressor impeller 5, a turbine housing 12 accommodating the turbine wheel 8, and a bearing housing 14 located between the compressor cover 10 and the turbine housing 12 in the axial direction of the rotating shaft 4. The compressor cover 10 and the bearing housing 14, and further, the turbine housing 12 and the bearing housing 14 may be fastened respectively with bolts (not illustrated).

The compressor cover 10 has an air inlet port 16 opened axially-outward at one end of the turbocharger 1 in the axial direction and forms a scroll (circular flow path) 18 located radially-outside the compressor impeller 5.

Further, the turbine housing 12 has an exhaust gas outlet port 20 opened axially outward at the other end of the turbocharger 1 in the axial direction and forms a scroll (circular flow path) 22 located radially-outside the turbine wheel 8.

The turbocharger 1 having the above configuration operates, for example, as follows.

Air flows toward the compressor impeller 5 via the air inlet port 16 and is compressed by the compressor impeller 5 rotating with the rotating shaft 4. The compressed air obtained as described above is once discharged from the turbocharger 1 via the scroll 18 formed radially-outside the compressor impeller 5 and supplied to a combustion engine (not illustrated).

In the combustion engine, fuel is combusted along with the compressed air and combustion gas is generated through the combustion reaction. The combustion gas, as exhaust gas discharged from the combustion engine, flows toward the turbine wheel 8 via the scroll 22 formed radially-outside the turbine wheel 8. Due to the flow of exhaust gas flowing as described above, rotational force is applied to the turbine wheel 8, and thereby, the rotating shaft 4 is driven. The exhaust gas having completed work in the turbine is discharged from the turbocharger 1 via the exhaust gas outlet port 20.

Next, the compressor impeller 5 (impeller 5) according to some embodiments will be described in detail.

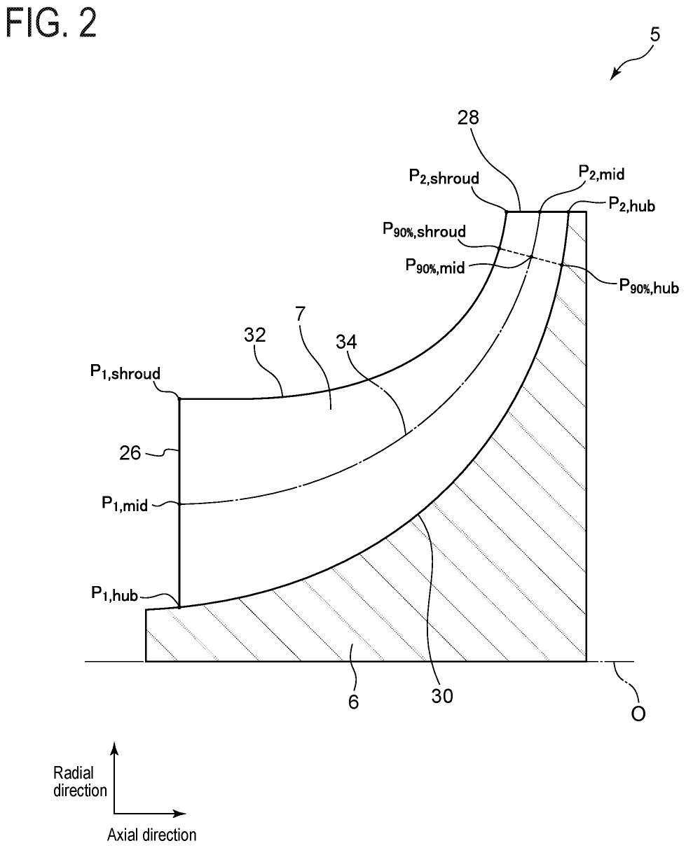

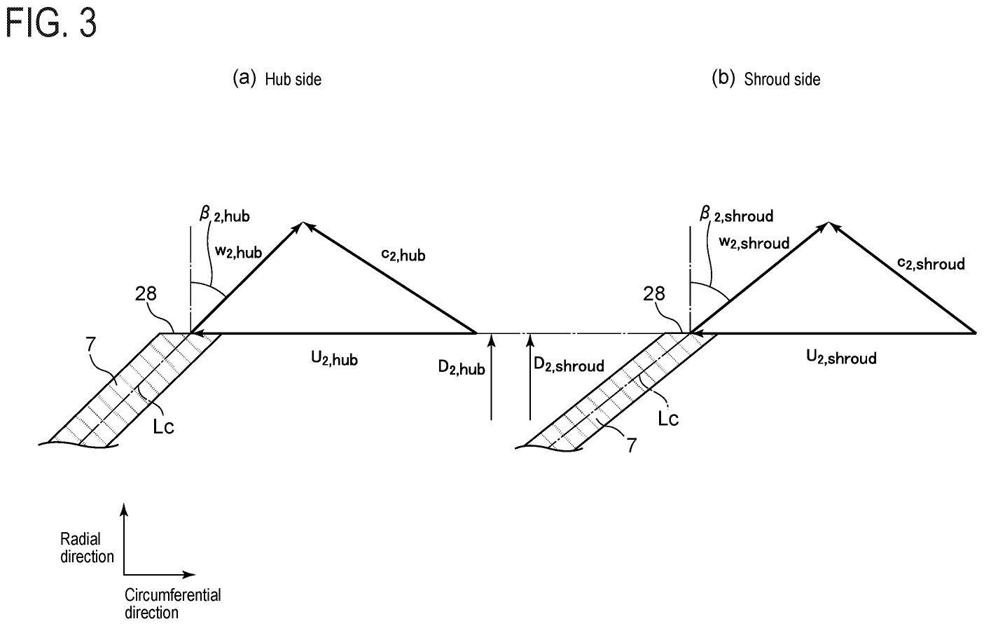

FIG. 2 is a schematic view illustrating a cross-section on a meridian plane of the impeller 5 according to an embodiment. FIG. 3 illustrates an iso-span cross-section (i.e., a cross-section at positions where spanwise positions are the same) of the blade 7 of the impeller 5 according to an embodiment, while part (a) of FIG. 3 is a schematic view of the iso-span cross-section at a hub-side end and part (b) of FIG. 3 is a schematic view of the iso-span cross-section at a shroud-side end. In FIG. 3, an outer diameter D_{2,hub} of the blade 7 at a hub-side end 30 and an outer diameter D_{2,shroud} of the blade 7 at a shroud-side end 32 are the same.

As illustrated in FIG. 2, the blades 7 arranged around the hub 6 of the impeller 5 are extended along the span direction between a leading edge 26 located at the most upstream side in the flow direction of fluid flowing toward the impeller 5 and a trailing edge 28 located at the most downstream side thereof, and between the hub-side end 30 and the shroud-side end (leading end) 32. The hub-side end 30 corresponds to a connection position of the blades 7 with the hub 6. The shroud-side end 32 is an end on the opposite side to the hub-side end 30 as being adjacent to the compressor cover 10 (see FIG. 1).

In this specification, the span direction is a direction connecting the hub-side end 30 and the shroud-side end 32 at each dimensionless meridian plane lengthwise position.

Further, in this specification, the dimensionless meridian plane lengthwise position represents a position on the meridian plane of a given spanwise position (e.g., a position of the hub-side end 30, a position of the shroud-side end 32, a center position 34 between the hub-side end 30 and the shroud-side end 32, or the like) with a relative meridian plane length (i.e., length on the meridian plane) having the leading edge 26 as a reference while the position at the leading edge 26 is denoted as 0% and the position at the trailing edge 28 is denoted as 100%. For example, a 0%-dimensionless meridian plane lengthwise position represents a position at the leading edge 26 on the meridian plane and a 100%-dimensionless meridian plane lengthwise position represents a position at the trailing edge 28. Further, a 90%-dimensionless meridian plane lengthwise position represents a position where a meridian plane length from the leading edge 26 is 90% of the meridian plane length from the leading edge 26 to the trailing edge 28.

As illustrated in FIG. 2, a position P_{2, shroud} of the shroud-side end 32, a position P_{2,hub} of the hub-side end 30, and a center position P_{2,mid} exist on the trailing edge 28 of the blade 7.

In some embodiments, on the trailing edge 28 of the blade 7, a blade angle at a first position on the shroud side from the center position P_{2,mid} (i.e., on the side close to the shroud-side end 32) in the span direction of the blade 7 is larger than a blade angle at a second position on the hub side from the center position P_{2,mid} (i.e., on the side close to the hub-side end 30).

In other words, the trailing edge 28 of the blade 7 has the first position and the second position where β_{2,B}<β_{2,A} is satisfied while β_{2,B} represents a blade angle at the second position between the center position P_{2,mid} and the position P_{2,hub} on the hub-side end and β_{2,A} represents a blade angle at the first position between the center position P_{2,mid} and the position P_{2,shroud} on the shroud-side end.

Here, the blade angle β is an angle formed by a camber line Lc of the blade 7 and a flow path direction (a direction matched to a radial direction on the paper plane in FIG. 3) on a plane of the iso-span cross-section (i.e., a cross-section at positions where spanwise positions are the same) (see FIG. 3).

Further, in this specification, the blade angle β at a position on the trailing edge 28 is called a backward angle as well and is sometimes denoted by β₂.

In some embodiments, further, β_{2,hub}<β_{2,shroud} is satisfied while β_{2,hub} (see part (a) of FIG. 3) represents a backward angle at the hub-side end 30 of the blade 7 and β_{2,shroud} (see part (b) of FIG. 3) represents a backward angle at the shroud-side end 32 of the blade 7.

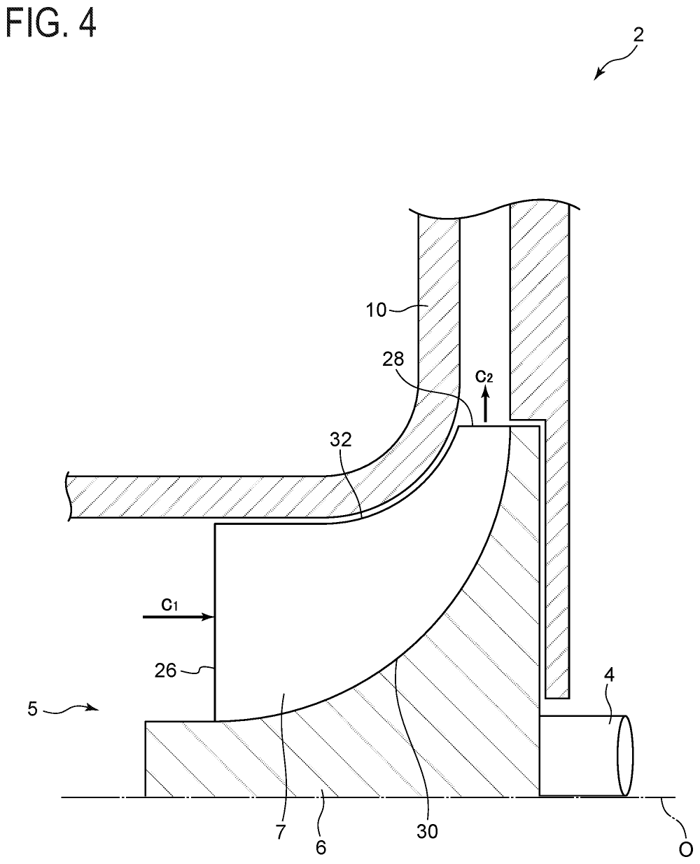

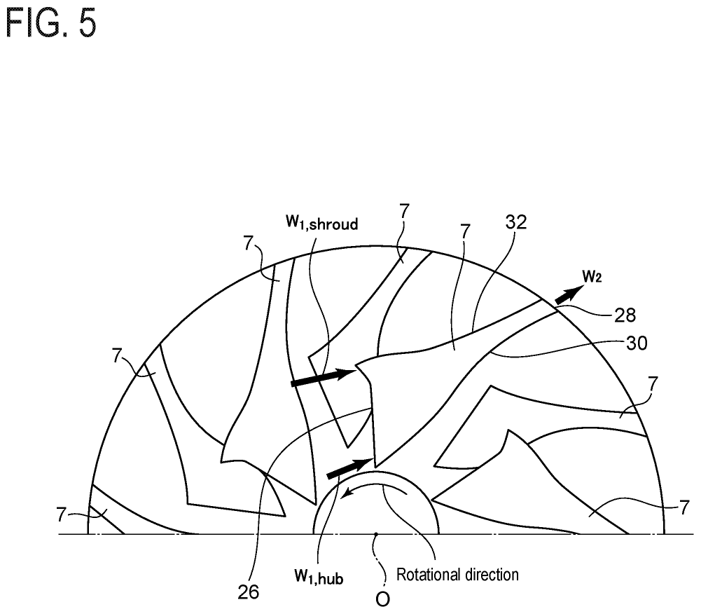

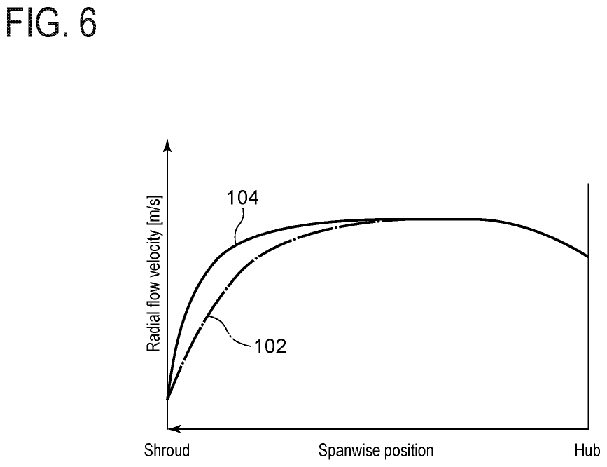

Effects of the above embodiments will be described with reference to FIGS. 3 to 6. FIG. 4 is a schematic cross-section on the meridian plane of the impeller 5 according to an embodiment. FIG. 5 is a schematic view viewing, in the axial direction, the impeller 5 according to an embodiment. FIG. 6 is a graph illustrating an example of a distribution of radial flow velocities of fluid in the span direction at a position on the trailing edge 28 of the blade 7.

As illustrated in FIG. 4, in the centrifugal compressor 2, an absolute velocity of the fluid at an inlet of the impeller 5 (i.e., the leading edge 26 of the blade 7) is denoted by c₁ and an absolute velocity of the fluid at an outlet of the impeller 5 (i.e., the trailing edge 28 of the blade 7) is denoted by c₂.

As can be seen from FIGS. 2 to 4, at the leading edge 26 of the blade 7, since the shroud side (leading end side) is located radially-outside the hub side, a blade speed (circumferential velocity) of the blade 7 at the shroud side is larger than that at the hub side. Accordingly, regarding a relative velocity w₁ of the fluid with respect to the blade 7 at the inlet of the impeller 5, a relative velocity w_{1,shroud} at the shroud side is larger than a relative velocity w_{1,hub} at the hub side (see FIG. 5).

On the other hand, the trailing edge 28 of the blade 7 stays at approximately the same position in the radial direction from the hub-side end 30 to the shroud-side end (leading end) 32. Accordingly, there is not a large difference of the blade speeds between those at the hub side and the shroud side. Therefore, provided that the backward angle β₂ is kept constant from the hub-side end 30 to the shroud-side end 32, there is not a large difference, at the outlet of the impeller 5, between a relative velocity w_{2,hub} at the hub side and a relative velocity w_{2,shroud} at the shroud side. Accordingly, a reduction ratio (w_{2,shroud}/w_{1,shroud}) of the fluid at the shroud side of the blade 7 becomes larger than a reduction ratio (w_{2,hub}/w_{1,hub}) at the hub side and blade load at the shroud side tends to be excessively large. A distribution of radial flow velocities of the fluid at the trailing edge 28 at that time is indicated by a curve line 102 in the graph of FIG. 6. Here, the radial flow velocity at the shroud side is lower than that at the hub side, which indicates that flow separation and secondary flow are occurring at the shroud side.

In this regard, in the above embodiment, since the blade angle β (backward angle β₂) at the trailing edge 28 of the blade 7 at the shroud side is larger than that at the hub side (e.g., β_{2,hub}<β_{2,shroud} is satisfied), at a position of the trailing edge 28 of the blade 7, the relative velocity w_{2,shroud} at the shroud side becomes larger than the relative velocity w_{2,hub} at the hub side (see FIG. 3).

Here, this is because that a radial component of the relative velocity w_{2,shroud} at the shroud side and a radial component of the relative velocity w_{2,hub} at the hub side are basically the same.

Accordingly, in the above embodiment, the reduction ratio (w_{2,shroud}/w_{1,shroud}) at the shroud side can be caused to be close to the reduction ratio (w_{2,hub}/w_{1,hub}) at the hub side, so that blade load at the shroud side can be suppressed from becoming excessively large. The distribution of radial flow velocities of the fluid at the trailing edge 28 at that time is indicated by a curve line 104 in the graph of FIG. 6. Here, compared to the curve line 102 indicating the case that the backward angle β₂ is constant, dropping of the radial flow velocity at the shroud side is reduced. That is, it is indicated that flow separation and secondary flow at the shroud side are suppressed. Thus, according to the above embodiment, performance of the centrifugal compressor 2 can be improved.

In FIG. 3, since the outer diameter D_{2,hub} of the blade 7 at the hub side and the outer diameter D_{2,shroud} of the blade 7 at the shroud side are the same, regarding a blade speed U₂ at the trailing edge 28 of the blade 7, a blade speed U_{2,hub} at the hub side is the same as a blade speed U_{2,shroud} at the shroud side. Accordingly, in this case, regarding the absolute velocity c₂ of the fluid at the trailing edge 28 of the blade 7, an absolute velocity c_{2,hub} at the hub side is larger than an absolute velocity c_{2,shroud} at the shroud side. Later-mentioned description refers to this point.

In some embodiments, the difference (β_{2,shroud}-β_{2,hub}) between the backward angle β_{2,shroud} at the shroud-side end 32 and the backward angle β_{2,hub} at the hub-side end 30 may be equal to or larger than 5 degrees (i.e., equal to or larger than 5°). Further, in some embodiments, the difference (β_{2,shroud}-β_{2,hub}) may be equal to or larger than 10° or may be equal to or larger than 15°.

Thus, owing to that the difference of the backward angles (β_{2,shroud}-β_{2,hub}) is set to be equal to or larger than 5°, equal to or larger than 10°, or equal to or larger than 15°, the reduction ratio (w_{2,shroud}/w_{1,shroud}) at the shroud side can be easily set close to the reduction ratio (w_{2,hub}/w_{1,hub}) at the hub side, so that blade load at the shroud side can be suppressed from becoming excessively large more effectively. According to the above, occurrence of flow separation and secondary flow due to excessively large blade load can be suppressed more effectively.

Further, in some embodiments, the difference (β_{2,shroud}-β_{2,hub}) between the backward angle β_{2,shroud} at the shroud-side end 32 and the backward angle β_{2,hub} at the hub-side end 30 may be equal to or smaller than 45°, equal to or smaller than 40°, or equal to or smaller than 35°.

When the difference of backward angles between those at the shroud side and the hub side is excessively large, the difference of the absolute velocities c₂ of fluid (see FIG. 3) becomes large at the trailing edge 28 of the blade 7 in some cases, and mixing loss is more likely to occur. In this regard, owing to that the difference (β_{2,shroud}-β_{2,hub}) of the backward angles is set be equal to or smaller than 45°, equal to or smaller than 40°, or equal to or smaller than 35°, the mixing loss can be reduced.

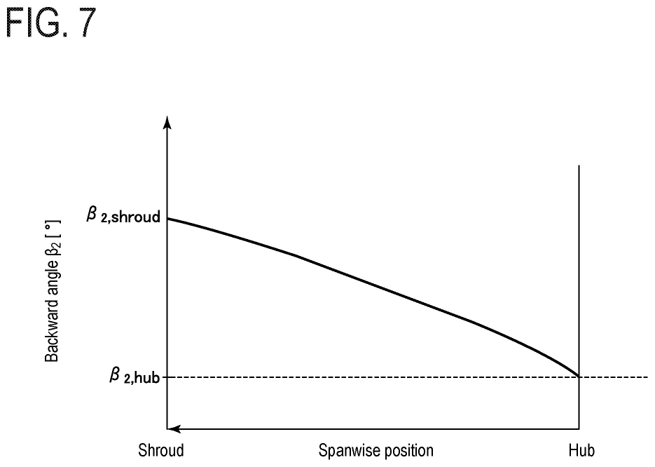

FIG. 7 is a graph illustrating a distribution of the backward angles β₂ of the blade 7 in the span direction according to an embodiment. In some embodiments, for example, as illustrated in FIG. 7, the backward angle β₂ of the blade 7 monotonically decreases from the shroud-side end 32 to the hub-side end 30.

Since the reduction ratio of the fluid at the blade 7 approximately depends on a radial position at a position of the leading edge 26 of the blade 7, there is a tendency that the reduction ratio is the largest at the shroud-side end 32 being the outermost radial position at the leading edge 26 and becomes gradually smaller toward the hub side. In this regard, as described above, owing to that the backward angle β₂ monotonically decreases from the shroud-side end 32 to the hub-side end 30, the reduction ratio at the shroud side can be effectively reduced, and thereby, blade load at the shroud side can be suppressed from becoming excessively large. According to the above, occurrence of flow separation and secondary flow due to excessively large blade load can be suppressed more effectively.

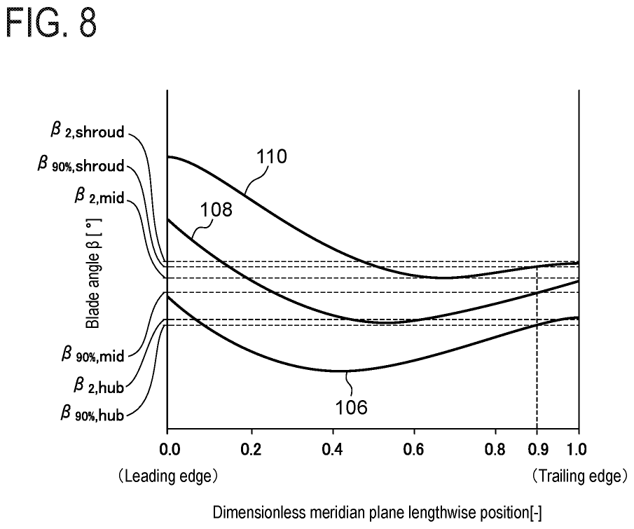

FIG. 8 is a graph illustrating a distribution of the blade angles of the blade 7 at dimensionless meridian plane lengthwise positions according to an embodiment. In FIG. 8, a curve line 106 indicates a blade angle distribution at the hub-side end 30, a curve line 108 indicates a blade angle distribution at the center position 34 in the span direction, and a curve line 110 indicates a blade angle distribution at the shroud-side end 32.

In some embodiments, the blade angle β does not vary drastically in the vicinity of the trailing edge 28 on the meridian plane.

More specifically, in some embodiments, an absolute value of the difference |β_{90%,hub}-β_{2,hub}| (see the curve line 106 in FIG. 8) between a blade angle β_{90%,hub} at the hub-side end 30 at a 90%-dimensionless meridian plane lengthwise position and the backward angle β_{2,hub} at the hub-side end 30 (i.e., the blade angle at the hub-side end 30 at a 100%-dimensionless meridian plane lengthwise position) is equal to or smaller than 10° or equal to or smaller than 5°.

Further, in some embodiments, an absolute value of the difference |β_{90%,shroud}-β_{2,shroud}| (see the curve line 110 in FIG. 8) between a blade angle β_{90%,shroud} at the shroud-side end 32 at a 90%-dimensionless meridian plane lengthwise position and the backward angle β_{2,shroud} at the shroud-side end 32 (i.e., the blade angle at the shroud-side end 32 at the 100%-dimensionless meridian plane lengthwise position) is equal to or smaller than 10° or equal to or smaller than 5°.

Further, in some embodiments, an absolute value of the difference |β_{90%,mid}-β_{2,mid}| (see the curve line 108 in FIG. 8) between a blade angle β_{90%,mid} at the center position 34 at a 90%-dimensionless meridian plane lengthwise position and a backward angle β_{2,mid} at the center position 34 (i.e., the blade angle at the center position 34 at the 100%-dimensionless meridian plane lengthwise position) is equal to or smaller than 10° or equal to or smaller than 5°.

Further, in some embodiments, an absolute value of the difference |β_{90%,}*-β_{2,}*| between a blade angle β_{90%,}* at an arbitrary spanwise position at a 90%-dimensionless meridian plane lengthwise position and a backward angle β_{2,}* at the same spanwise position (i.e., a blade angle at the spanwise position at the 100%-dimensionless meridian plane lengthwise position) is equal to or smaller than 10° or equal to or smaller than 5°.

When the blade angle β varies drastically in the vicinity of the trailing edge 28 of the blade 7 (i.e., in a positional range from a position slightly closer to the leading edge 26 than the trailing edge 28 to the trailing edge 28), there arise possibilities that flow in the positional range does not follow the blade 7 and that the effect to be obtained by relatively enlarging the backward angle β₂ at the shroud side, that is, the effect to suppress occurrence of flow separation and secondary flow due to excessively large blade load cannot be obtained.

In this regard, according to the above embodiments, since the difference, at a given spanwise position (e.g., positions at the hub-side end 30 and the shroud-side end 32, and the like), between the blade angle β at a 90%-dimensionless meridian plane lengthwise position of the blade 7 and the backward angle β₂ is set equal to or smaller than 10°, variation of the blade angle β in the vicinity of the trailing edge 28 of the blade 7 becomes relatively gradual. Accordingly, the effect to be obtained by relatively enlarging the backward angle β₂ at the shroud side, that is, the effect to suppress occurrence of flow separation and secondary flow due to excessively large blade load can be sufficiently obtained.

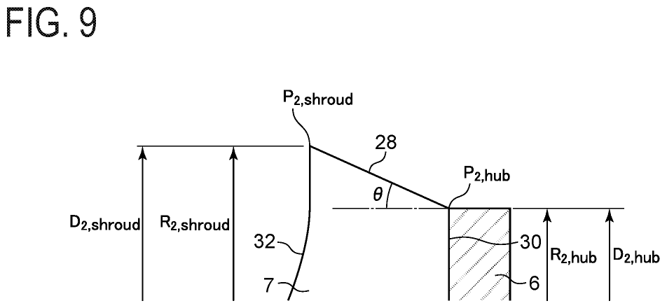

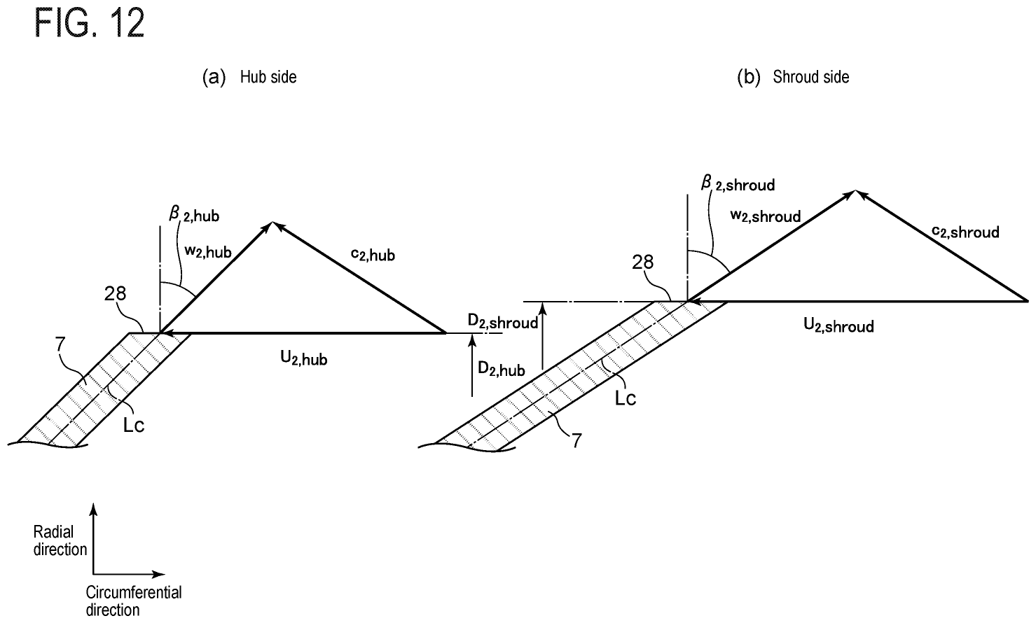

FIGS. 9 to 11 are schematic cross-sectional views on a meridian plane each illustrating a vicinity of the trailing edge 28 of the blade 7 of the impeller 5 according to an embodiment. FIG. 12 schematically illustrates an iso-span cross-section of the blade 7 of the impeller 5 according to an embodiment, while part (a) of FIG. 12 is a schematic view of the iso-span cross-section at the hub-side end and part (b) of FIG. 12 is a schematic view of the iso-span cross-section at the shroud-side end.

In FIGS. 9 to 12, R_{2,hub} represents a distance in the radial direction between the hub-side end 30 of the blade 7 and the center axis O and D_{2,hub} represents an outer diameter of the blade 7 at the hub-side end 30. That is, D_{2,hub}=2×R_{2,hub} is satisfied.

Further, in FIGS. 9 to 12, R_{2,shroud} represents a distance in the radial direction between the shroud-side end 32 of the blade 7 and the center axis O and D_{2,shroud} represents an outer diameter of the blade 7 at the shroud-side end 32. That is, D_{2,shroud}=2×R_{2,shroud} is satisfied.

Here, in FIG. 12, the outer diameter of D_{2,shroud} of the blade 7 at the shroud-side end 32 is larger than the outer diameter D_{2,hub} of the blade 7 at the hub-side end 30.

In some embodiments, as illustrated for example in FIGS. 9 to 11, the distance R_{2,hub} between the center axis O of the impeller 5 and the hub-side end 30 of the trailing edge 28 of the blade 7 and the distance R_{2,shroud} between the center axis O of the impeller 5 and the shroud-side end 32 of the trailing edge 28 of the blade 7 satisfy R_{2,hub}<R_{2,shroud}. That is, on the meridian plane, a straight line at the trailing edge 28 of the blade 7 connecting the position P_{2,hub} of the hub-side end 30 and the position P_{2,shroud} of the shroud-side end 32 is inclined with respect to the axial direction of the impeller 5. That is, on the meridian plane, an angle θ (see FIGS. 9 to 11) formed between the straight line connecting P_{2,hub} and P_{2,shroud} and the axial direction of the impeller 5 is larger than 0°.

As described with reference to FIG. 3, in the case that the outer diameter D_{2,hub} of the blade 7 at the hub side is equal to the outer diameter D_{2,shroud} of the blade 7 at the shroud side, the difference of absolute velocities c₂ of the fluid at the trailing edge 28 of the blade 7 occurs between those at the hub side and the shroud side by causing backward angles at the blade 7 of the impeller 5 to have a distribution. More specifically, when the outer diameter D_{2,hub} of the blade 7 at the hub side is equal to the outer diameter D_{2,shroud} of the blade 7 at the shroud side, regarding the absolute velocity c₂ of the fluid at the trailing edge 28 of the blade 7, the absolute velocity c_{2,hub} at the hub side is larger than the absolute velocity c_{2,shroud} at the shroud side. Thus, when the absolute velocity of the fluid is not uniformed in the vicinity of the trailing edge 28, mixing loss may be caused.

In this regard, according to the above embodiments, since the shroud side of the trailing edge 28 of the blade 7 is located radially-outside the hub side (i.e., the outer diameter D_{2,shroud} at the shroud side of the blade 7 is set larger than the outer diameter D_{2,hub} at the hub side), the blade speed U_{2,shroud} at the shroud side at the trailing edge 28 of the blade 7 can be relatively large compared to a case that outer diameters at the shroud side and the hub side are the same (see FIG. 3). Accordingly, as illustrated in FIG. 12, the absolute velocity c_{2,shroud} of the fluid at the shroud side can be set relatively large.

Accordingly, the difference in the vicinity of the trailing edge 28 of the blade 7 between the absolute velocity c_{2,shroud} of the fluid at the shroud side and the absolute velocity c_{2,hub} at the hub side can be reduced and mixing loss to be caused by the difference of the absolute velocities c₂ of the fluid at the outlet of the impeller 5 can be suppressed.

In some embodiments, the distance R₂ between the center axis O of the impeller 5 and the trailing edge 28 of the blade 7 may monotonically decrease from the shroud-side end 32 to the hub-side end 30. According to the shape described above, the absolute velocity c₂ of the fluid at the trailing edge 28 is easily uniformed and mixing loss can be effectively suppressed.

In some embodiments, on the meridian plane of the impeller 5, the angle θ (see FIGS. 9 to 11) formed between the straight line connecting the shroud-side end 32 and the hub-side end 30 at the trailing edge 28 of the blade 7 and the axial direction of the impeller 5 may be 10° or larger.

In this case, the effect to uniform the absolute velocity c₂ of the fluid at the trailing edge 28 is more likely to be obtained and mixing loss can be suppressed more effectively.

In some embodiments, the angle θ may be equal to or smaller than 60° or equal to or smaller than 45°.

In this case, since the positional difference in the radial direction between the hub-side end 30 and the shroud-side end 32 at the trailing edge 28 of the blade 7 is not excessively large, stress occurring at the blade 7 can be suppressed from being increased.

In an embodiment, the angle θ may be equal to or larger than 10° and equal to or smaller than 45°. In this case, the absolute velocity c₂ of the fluid at the trailing edge 28 is easily uniformed while suppressing stress occurring at the blade 7 from being increased.

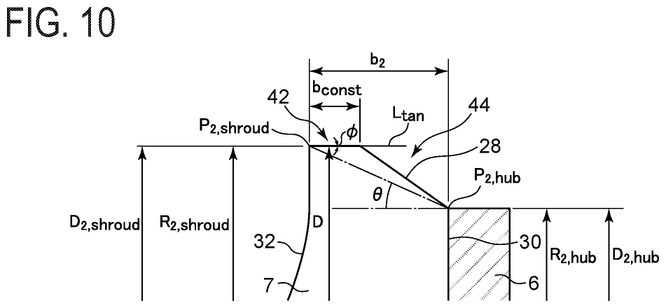

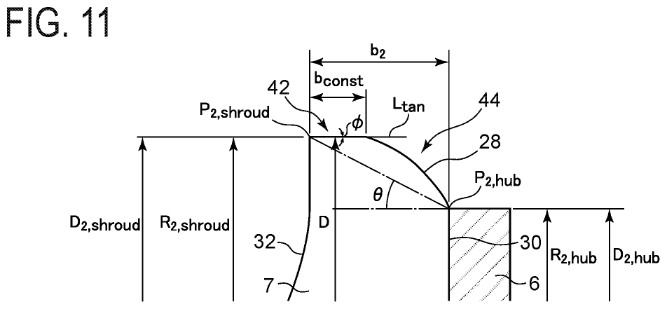

In some embodiments, on the meridian plane of the impeller 5, the outer diameter D of the impeller 5 in a first region 42 (see FIGS. 10 and 11) in an axial range including the position P_{2,shroud} on the trailing edge 28 of the blade 7 and on the shroud-side end 32 satisfies D_{2,shroud}−0.01×D_{2,hub}≤D≤D_{2,shroud}+0.01×D_{2,hub}. That is, in the first region 42, the outer diameter D of the impeller 5 is approximately constant as having a small difference with respect to the outer diameter D_{2,shroud} at the shroud side.

Further, in some embodiments, on the meridian plane of the impeller 5, an angle φ formed between the axial direction of the impeller 5 and a direction of a tangential line Lₜₐₙ (see FIGS. 10 and 11) of the trailing edge 28 in the first region 42 is 5° or smaller. That is, in the first region 42, the tangential line Lₜₐₙ is approximately in parallel to the axial direction and the outer diameter D of the impeller 5 is approximately constant.

Here, in FIGS. 10 and 11, the angle φ is almost zero.

There may be a case that reverse flow is likely to occur at the shroud side depending on operational conditions of the centrifugal compressor (e.g., low flow velocity conditions, and the like). In this regard, since the first region 42 including the shroud-side end 32 at which the outer diameter D of the impeller 5 is relatively large and does not vary largely is arranged at the shroud side of the blade 7, the impeller blade speed can be set relatively large in the first region 42, and thereby, reverse flow which may occur at the shroud side can be effectively suppressed. Thus, according to the above embodiment, mixing loss due to the difference of absolute velocities of the fluid at the outlet of the impeller 5 can be suppressed while suppressing reverse flow which may occur at the shroud side, as described above.

In some embodiments, on the meridian plane of the impeller 5, b₂ and b_{const} satisfy b_{const}≥0.1×b₂, where b₂ represents a length in the axial direction between the shroud-side end 32 and the hub-side end 30 at a position on the trailing edge 28, and b_{const} represents a length of the first region 42 in the axial direction (see FIGS. 10 and 11). Alternatively, in some embodiments, b₂ and b_{const} satisfy b_{const}≥0.2×b₂.

In this case, since the first region 42 is sufficiently wide in the axial direction, the difference of the absolute velocities c₂ of the fluid between those at the shroud side and the hub side can be effectively reduced. Accordingly, mixing loss due to the difference of the absolute velocities c₂ of the fluid at the outlet of the impeller 5 can be effectively suppressed.

Further, in some embodiments, b₂ and b_{const} described above satisfy b_{const}≤0.5×b₂. Alternatively, in some embodiments, b₂ and b_{const} satisfy b_{const}≤0.3×b₂.

According to the above embodiments, since the length b_{const} of the first region 42 in the axial direction in which the outer diameter D of the impeller 5 does not vary largely is set to equal to or lower than 50% or equal to or lower than 30% of the length b₂ of the trailing edge 28 of the blade 7 in the axial direction, mixing loss due to the difference of the absolute velocities of the fluid at the outlet of the impeller 5 can be effectively suppressed while appropriately maintaining strength of the blade.

In some embodiments, b₂ and b_{const} may satisfy 0.1×b₂≤b_{const}≤0.3×b₂.

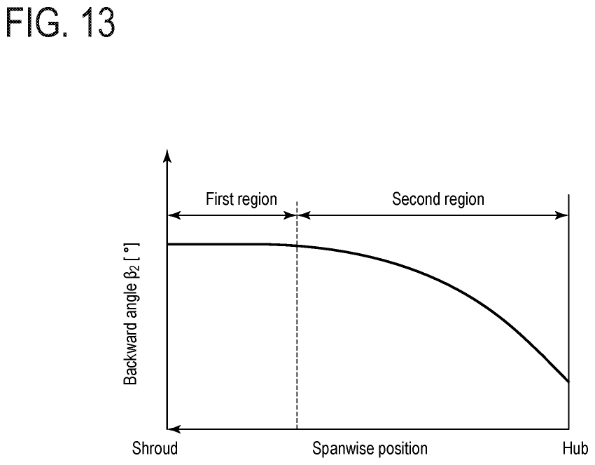

FIG. 13 is a graph illustrating a distribution of the backward angles β₂ of the blade 7 in the span direction according to an embodiment.

In some embodiments, on the meridian plane of the impeller 5, a ratio β_{2,R1-max}/β_{2,R1-min} which is a ratio of a maximum value β_{2,R1-max} to a minimum value β_{2,R1-min} of backward angles of the blade 7 in the first region 42 on the trailing edge 28 of the blade 7 is smaller than a ratio β_{2,R2-max}/β_{2,R2-min} which is a ratio of a maximum value β_{2,R2-max} to a minimum value β_{2,R2-min} of backward angles in a second region 44 (see FIGS. 10 and 11), the second region 44 being closer to the hub-side end 30 than the first region 42 on the trailing edge 28 of the blade 7.

In this case, for example, as illustrated in FIG. 13, a variation rate of the backward angle β₂ in the first region 42 being relatively close to the shroud side is smaller than that in the second region 44 being relatively close to the hub side.

According to the above embodiment, since the backward angle β₂ in the first region 42 in which the outer diameter D of the impeller 5 does not vary largely is set not to largely vary, both of suppression of mixing loss at the outlet of the impeller 5 and suppression of excessively large blade load at the shroud side can be achieved while appropriately maintaining strength of the blade 7.

In some embodiments, for example, as illustrated in FIG. 13, in a graph in which the horizontal axis represents the spanwise position at the trailing edge 28 and the vertical axis represents the backward angle, a curve line indicating the relation between the spanwise direction and the backward angle β₂ has a shape concaved upward.

In this case, compared to a case that the backward angle is varied linearly with respect to the spanwise direction, since a spanwise region in which the backward angle β₂ is relatively large is increased, mixing loss at the outlet of the impeller 5 and excessively large blade load at the shroud side can be effectively suppressed.

In the above, description has been provided on the embodiments of the present invention. However, not limited to the embodiments described above, the present invention includes modifications of the embodiments and appropriate combinations thereof.

In the present application, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For example, an expression of an equal state such as “same”, “equal” and “uniform” shall not be construed as indicating only the state in which the feature is strictly equal, but also includes a state in which there is a tolerance or a difference that can still achieve the same function.

Further, in the present application, an expression of a shape such as a rectangular shape or a cylindrical shape shall not be construed as only the geometrically strict shape, but also includes a shape with unevenness or chamfered corners within the range in which the same effect can be achieved.

Further, in the present application, an expression such as “comprise”, “include”, and “have” are not intended to be exclusive of other components.

1. An impeller for a centrifugal compressor, comprising:
a plurality of blades arranged around a hub,
wherein on a trailing edge of the blade, a blade angle at a first position on a shroud side from a center position in a span direction of the blade is larger than a blade angle at a second position on a hub side from the center position.

2. The impeller for a centrifugal compressor according to claim 1,
wherein β_{2,hub} and β_{2,shroud} satisfy β_{2,hub}<β_{2,shroud},
where β_{2,hub} represents a blade angle at a position on the trailing edge and on a hub-side end of the blade and β_{2,shroud} represents a blade angle at a position on the trailing edge and on a shroud-side end of the blade.

3. The impeller for a centrifugal compressor according to claim 2,
wherein β_{2,hub} and β_{2,shroud} satisfy β_{2,shroud}-β_{2,hub}≥5°.

4. The impeller for a centrifugal compressor according to claim 2,
wherein β_{2,hub} and β_{90%,hub} satisfy |β_{90%,hub}-β_{2,hub}|≤10°,
where β_{90%,hub} represents a blade angle at a 90%-dimensionless meridian plane lengthwise position on the hub-side end of the blade.

5. The impeller for a centrifugal compressor according to claim 2,
wherein β_{2,shroud} and β_{90%,shroud} satisfy |β_{90%,shroud}-β_{2,shroud}|≤10°,
where β_{90%,shroud} represents a blade angle at a 90%-dimensionless meridian plane lengthwise position on the shroud-side end of the blade.

6. The impeller for a centrifugal compressor according to claim 1,
wherein a blade angle at a position on the trailing edge of the blade monotonically decreases from a shroud-side end of the blade to a hub-side end of the blade.

7. The impeller for a centrifugal compressor according to claim 1,
wherein R_{2,hub} and R_{2,shroud} satisfy R_{2,hub}<R_{2,shroud},
where R_{2,hub} represents a distance between a center axis of the impeller and the hub-side end on the trailing edge of the blade and R_{2,shroud} represents a distance between the center axis and the shroud-side end on the trailing edge of the blade.

8. The impeller for a centrifugal compressor according to claim 7,
wherein an angle formed, on a meridian plane of the impeller, between an axial direction of the impeller and a straight line connecting the shroud-side end and the hub-side end on the trailing edge of the blade is 60° or smaller.

9. The impeller for a centrifugal compressor according to claim 7,
wherein an outer diameter D of the impeller, on a meridian plane of the impeller, in a first region in an axial range including a position on the trailing edge and on the shroud-side end satisfies D_{2,shroud}−0.01×D_{2,hub}≤D≤D_{2,shroud}+0.01×D_{2,hub},
where D_{2,hub} represents an outer diameter of the impeller at the hub-side end and D_{2,shroud} represents an outer diameter of the impeller at the shroud-side end.

10. The impeller for a centrifugal compressor according to claim 7,
wherein an angle φ formed, on a meridian plane of the impeller, between an axial direction of the impeller and a tangential direction of the trailing edge in a first region in an axial range including a position on the trailing edge and on the shroud-side end is 5° or smaller.

11. The impeller for a centrifugal compressor according to claim 9,
wherein on the meridian plane of the impeller, b₂ and b_{const} satisfy b_{const}≤0.5×b₂,
where b₂ represents a length in the axial direction between the shroud-side end at a position on the trailing edge of the blade and the hub-side end at a position on the trailing edge, and b_{const} represents a length of the first region in the axial direction.

12. The impeller for a centrifugal compressor according to claim 9,
wherein on the meridian plane of the impeller, a ratio β_{2,R1-max}/β_{2,R1-min} which is a ratio of a maximum value β_{2,R1-max} to a minimum value β_{2,R1-min} of blade angles in the first region on the trailing edge of the blade is smaller than a ratio β_{2,R2-max}/β_{2,R2-min} which is a ratio of a maximum value β_{2,R2-max} to a minimum value β_{2,R2-min} of blade angles in a second region on the trailing edge of the blade, the second region being closer to the hub-side end than the first region on the trailing edge.

13. A centrifugal compressor, comprising:
the impeller according to claim 1; and
a housing accommodating the impeller.

14. The centrifugal compressor according to claim 13,
wherein the centrifugal compressor is a single-stage compressor including the impeller as a single impeller.

15. A turbocharger, comprising:
the centrifugal compressor according to claim 13; and
a turbine configured to drive the centrifugal compressor.
